(19) United States
(12) Patent Application Publication
(10) Pub. No.: US 2021/0179427 A1
(43) Pub. Date: Jun. 17, 2021

(54) METHODS FOR PRODUCING BORON NITRIDE CONTAINING FLUIDS

(71) Applicant: CPI Innovations Services Limited, Cleveland (GB)

(72) Inventor: Stephen DEVINE, Hebburn (GB)

(21) Appl. No.: 17/268,835

(22) PCT Filed: Aug. 16, 2019
(86) PCT No.: PCT/GB2019/052315

§ 371 Date: Feb. 16, 2021

(30) Foreign Application Priority Data
Aug. 16, 2018 (GB) 1813414.8

(51) Int. Cl. C01B 21/064; C10M 125/26; C09K 5/10

(52) U.S. Cl. CPC C01B 21/0648; B82Y 30/00; C09K 5/10; C10M 125/26

(57) ABSTRACT

The present invention provides a method of producing a boron nitride containing fluid comprising the steps of: providing boron nitride; oxidising the boron nitride to functionalise the surface of the boron nitride; and dispersing the oxidised boron nitride in a base fluid to produce the boron nitride containing fluid. Associated boron nitride containing fluids and its use are also disclosed.

### FIELD OF THE INVENTION

The present invention relates to a method for producing boron nitride containing fluids. The invention further relates to boron nitride containing fluids and use of the same in various applications.

### BACKGROUND TO THE INVENTION

Boron nitride is a 2D, crystalline material consisting of single layers of two covalently bonded elements. Boron nitride exists in four physical varieties: amorphous form; hexagonal form; cubic form; and wurtzite form. Each of the physical varieties have the same chemical formula, it is the bonds between which that differ resulting in different physical properties between the four variants.

Hexagonal and cubic boron nitride have equivalent structures to graphite and diamond respectively. Both forms exhibit good thermal conductivity lending such materials to uses as heat transfer additives and the like. However, the cubic form is relatively unstable compared to the hexagonal form which renders such form of lesser use commercially.

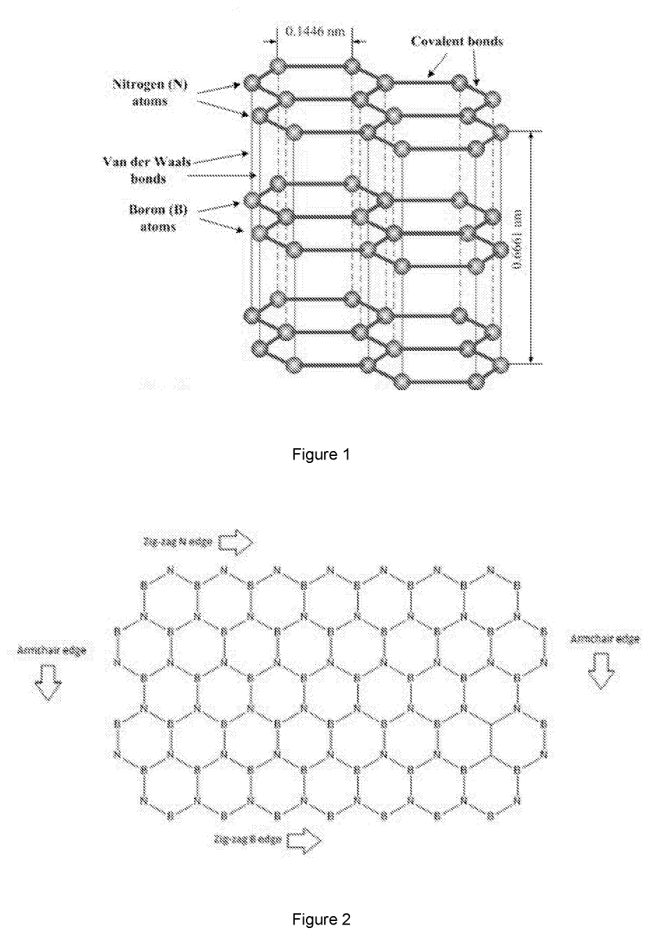

Hexagonal boron nitride has a layered structure as shown in FIG. 1. Within each layer, boron and nitrogen atoms are strongly bonded together via covalent bonds, whereas the layers are held together with weak Van der Waals forces.

The interlayer registry of the sheets differs from that seen with graphite for example, as the atoms are eclipsed with boron atoms lying over and above nitrogen atoms due to their size difference. FIG. 2 shows what this structure looks like from above and highlights how different edge effects can be presented in a single sheet, namely a zig-zag N edge and a zig-zag B edge along the upper and lower edges as shown and armchair edges along each of the side edges.

Hexagonal boron nitride (h-BN) shows remarkable chemical and thermal stabilities. h-BN is stable to decomposition at temperatures up to 1000° C. in air. Table 1 shows selected physical properties of hexagonal boron nitride.

TABLE 1
Selected physical properties of hexagonal boron nitride (S = surface, L = layer)

| Density | 2.1 g.cm⁻³ |
|---|---|
| Bulk Modulus | 36.5 GPa |
| Thermal Conductivity | 600 (S), 30 (L) W/m.k |
| Thermal Expansion | −2.7 (S), 38 (L) (10⁶/° C.) |
| Bandgap | 5.5 eV |
| Refractive Index | 1.8 |

Thermal conductivity is a measure of the ability of a material to allow the flow of heat from its warmer surface through the material to its colder surface and is expressed in watts per kelvin per meter (W/m·k). As is evidenced in the above table, the layered physical form drastically affects the thermal conductivity of the material. In particular, thermal conductivity across the surface of h-BN is very high (600 W/m·k) but only 30 W/m·k across the layers. This shows that heat readily transfers across the lattice through the covalently bonded atoms but there is poor thermal transfer (equivalent to zinc oxide for example) across the layers which are held together by weak Van der Waals forces.

Consequently, in order to achieve an efficient heat transfer additive, a material with only heat transfer across the surface is desirable. This can be achieved by having single layers of hexagonal boron nitride.

In order to achieve a single layer, or as close as possible i.e. 1 to 2 layers, multi-layer h-BN can be processed through a technique known as liquid exfoliation, which produces single layer platelets of material. This process has been extensively reported by Coleman, J. N. et al, 2011. “Two-dimensional Nanosheets Produced by Liquid Exfoliation of Layered Materials.” Science 331 (6017): 568 and has been adopted by many manufacturers in the field as the basis for their hexagonal boron nitride production technique.

This technique uses a solvent to penetrate the layers of a 2D material to “bloat” the distance between adjacent layers, which in turn weakens the Van der Waals bond. The solvent used is dictated by the surface properties of the materials (surface energy); the closer the match between the surface energy of the solid and the surface tension of the liquid then the easier exfoliation should be. Boron nitride has a low surface energy so requires a solvent with a low surface tension, such as isopropanol, to be employed in the technique. Accordingly, there is a relatively short window for the match between the surface energy of boron nitride and the surface tension of the solvent to be effective. Ultrasonic energy is then used to create cavitation between the layers thus forcing the layers apart. However, this is an extremely inefficient process that requires further processing via centrifugation to separate the single (or close to single) layer target. In particular, efficiencies of up to 5% of the single layer target are typical for this processing technique as a single run, though material can be reprocessed to improve this figure.

While the Coleman technique may generate a material with improved thermal properties, it has not been possible to utilise these materials in heat transfer applications. This is because hexagonal boron nitride is not readily wettable with water, as is required in such applications, as it clumps together and settles out of the dispersion. Surfactants have been used in order to overcome this problem and enable the material to form a stable dispersion in water. However, the thermal properties of hexagonal boron nitride in fluids may be degraded due to the presence of large surfactant molecules on the surface of the particle. This is because the large flexible surfactant molecules hinder the transfer of heat energy into and out-of the particles. As such, it has not been possible to provide dispersions of commercially available boron nitride for heat transfer/exchange applications using methods known in the art.

Accordingly, there exists a need in the art to provide a more efficient process for exfoliating hexagonal boron nitride to produce single layer (or close to single layer) materials in higher yields for subsequent use as a dispersion, preferably a nanofluid, in heat transfer and lubrication fluids applications and without requiring the presence of surfactants.

### SUMMARY OF THE INVENTION

In accordance with a first aspect of the present invention, there is provided a method for producing a boron nitride containing fluid comprising the steps of:
providing boron nitride;
oxidising the boron nitride to functionalise the surface of the boron nitride; and
dispersing the oxidised boron nitride in a base fluid to produce the boron nitride containing fluid.

It has been surprisingly found that functionalization of the surface of boron nitride by oxidation produces a material with significantly weakened interlayer bonds, which can be easily broken in use or by subsequent sonication or centrifugation. The oxidation of boron nitride also enhances the wettability of the boron nitride, thus rendering it more easily dispersed in fluids such as water and in greater yields (approximately 25% greater than by the prior art liquid exfoliation methods) and with greatly improved stability in the resulting dispersions. The resulting materials are therefore suitable for use in heat transfer fluids in various applications including electronics cooling, as well as lubricants and thermal fluids for metalworking processes.

By “oxidising” it is meant that the surface of the boron nitride is functionalised by the addition of oxygen. In one or more embodiments, an oxidising agent may be used to add oxygen or oxygen containing functional groups (for example, OH or COOH) to the surface of the boron nitride. The oxygen or oxygen containing functional groups are covalently bonded to the surface of the boron nitride at available junctions. The presence of such oxygen containing functional groups on the surface of the boron nitride acts as an effective surfactant to enhance wettability and stabilise the boron nitride particles in the dispersion with the base fluid.

In some embodiments, the method may further comprise the step of sonicating the dispersion. Sonication is preferred where the boron nitride containing material is intended for use as a heat transfer fluid, to enhance the yield of single layers in the material. However, this step may be omitted where the material is intended for use as a lubricant as generation of single layer boron nitride will occur in use, thus enhancing heat transfer properties of the fluid.

The boron nitride containing fluid may be a nanofluid. A nanofluid is a fluid containing nanometre-sized particles (i.e. boron nitride) in a colloidal suspension or dispersion with a base fluid. Nanofluids have properties which lend themselves to use in heat transfer or exchange applications as they exhibit enhanced thermal conductivity and convective heat transfer coefficient compared to the base fluid alone.

The boron nitride may be provided in powder form. Alternatively, the boron nitride may be provided in solution. Where the boron nitride is provided in solution, the boron nitride may be extracted from the solution prior to oxidation.

The boron nitride may be in the hexagonal or cubic form. Preferably the boron nitride is hexagonal. The boron nitride may be any commercially available boron nitride, wherein oxidation of the surface of the boron nitride occurs post synthesis. Such forms of boron nitride typically consist essentially of the multi-layer material. In one embodiment the hexagonal boron nitride may be turbostratic.

In some embodiments, oxidising the boron nitride may comprise treating the boron nitride with plasma. The boron nitride may be treated with plasma in the presence of an inert gas and an oxidising agent. For example, the inert gas may be argon gas and the oxidising agent may be oxygen gas or a carboxylic acid such as acetic acid (wherein the argon gas is bubbled through the carboxylic acid to form a vapour). The use of gases may be preferred for safety reasons.

The boron nitride may be oxidised for 10 minutes to 5 hours, for example for 30 minutes to 4 hours. The oxidation time may dependent upon the batch size. In some embodiments, the boron nitride may be oxidised for 2 hours.

The base fluid may comprise water, ethylene glycol or oil. Where ethylene glycol or oil is selected as the base fluid, the surface chemistry of the boron nitride may require modification by methods well known in the art to ensure that the surface energy closely matches the surface tension of ethylene glycol or the oil to provide a suitable dispersion. Optionally, the oxidised boron nitride is dispersed in water. Deionised water may be preferred where the intended use of the boron nitride containing fluids is in electronic cooling as it will maintain the dielectric properties required in case of spillage onto the electronics, or for use as an additive, where the presences of ions in the water may affect the properties of other additives.

In some embodiments a mixer may be used to aid dispersion of the oxidised boron nitride in the base fluid.

Where the step of sonicating the dispersion is employed, this may comprise subjecting the ultrasound for a time period of from 10 minutes to 10 hours, for example for a time period of from 10 to 60 minutes or a time period of from 1 to 4 hours. The sonication time will depend upon whether the yield of single layer boron nitride is preferred for a specific use.

The method may further comprise the step of centrifuging the boron nitride containing fluid, to further enhance separation of the layers.

In a second aspect of the present invention, there is provided a boron nitride containing fluid prepared by the method of the first aspect of the invention. The fluid may be a nanofluid.

In a third aspect of the present invention, there is provided a heat transfer fluid comprising a boron nitride containing fluid prepared by the method of the first aspect of the present invention.

In a fourth aspect of the present invention, there is provided use of the heat transfer fluid according to the third aspect of the present invention in electronics cooling system.

In a fifth aspect of the present invention, there is provided use of the heat transfer fluid according to the fourth aspect of the present invention in a solar panel.

In a sixth aspect of the present invention, there is provided a dual function heat exchange and lubricity additive comprising a boron nitride containing fluid prepared by the method of the first aspect of the present invention.

In a seventh aspect of the present invention, there is provided a lubricant comprising a boron nitride containing fluid prepared by the method of the first aspect of the present invention.

In an eighth aspect of the present invention, there is provided use of the dual function heat exchange and lubricity additive according to the sixth aspect of the present invention as a cutting fluid.

In a ninth aspect of the present invention, there is provided use of the lubricant according to the seventh aspect of the present invention as a cutting fluid.

The various embodiments of the first aspect of the present invention apply mutatis mutandis to the second to ninth aspects of the present invention.

### DETAILED DESCRIPTION

Embodiments of the present invention will now be described with reference to the following, non-limiting examples and figures.

FIG. 1 illustrates the structure of hexagonal boron nitride;

FIG. 2 illustrates the top-down view of a single layer of hexagonal boron nitride;

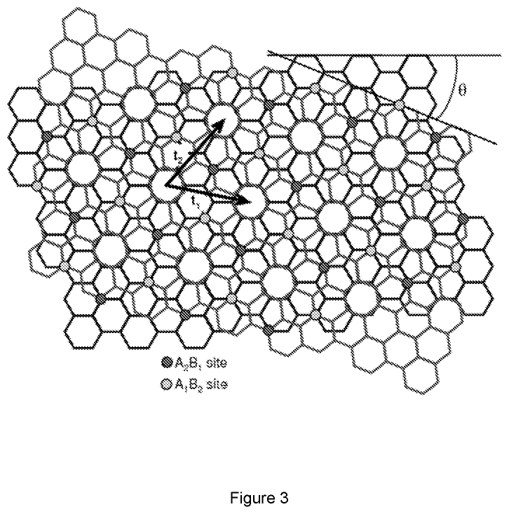

FIG. 3 illustrates the turbostratic structure of a first commercially available form of boron nitride;

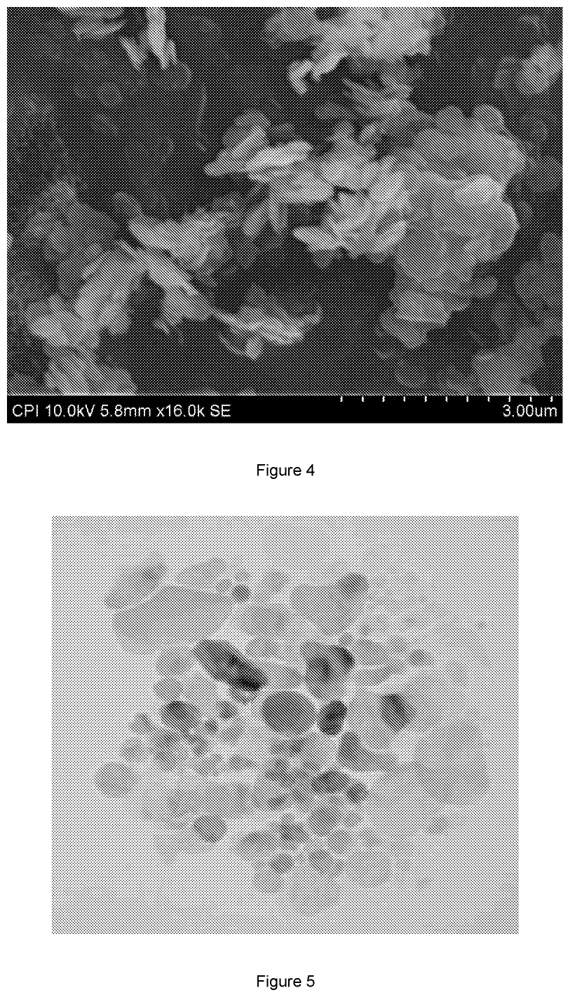

FIG. 4 shows an electron micrograph of the commercially available form of boron nitride of FIG. 3;

FIG. 5 shows a TEM micrograph of a second commercially available form of hexagonal boron nitride;

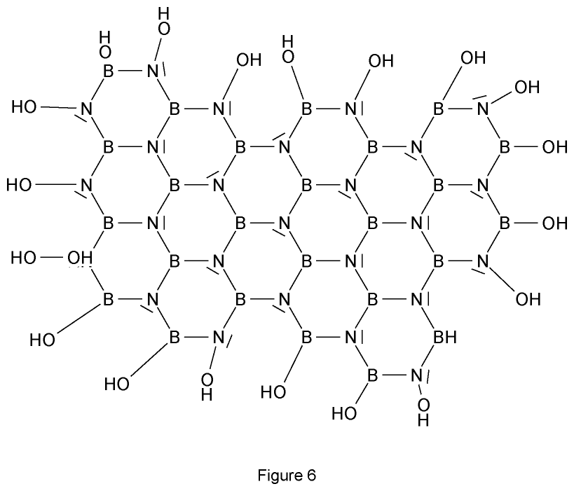

FIG. 6 illustrates functionalisation of a single layer of hexagonal boron nitride by oxidation;

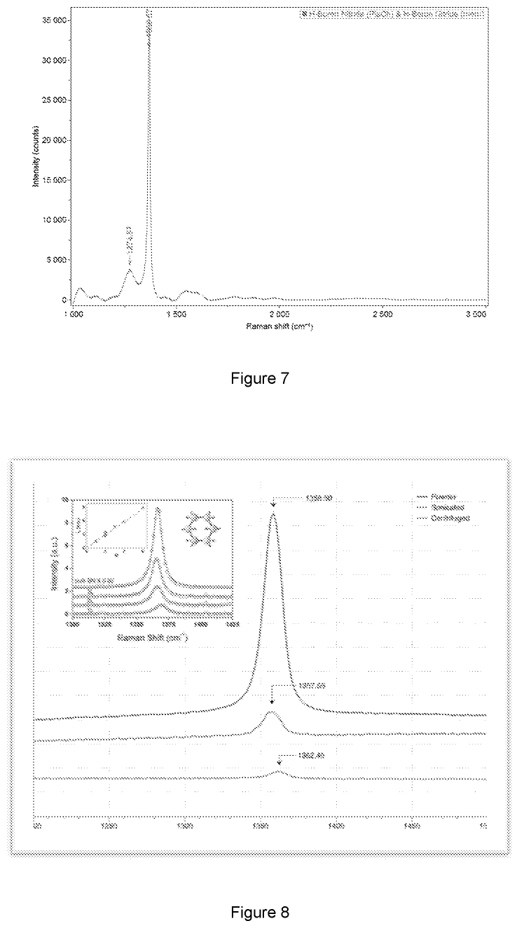

FIG. 7 shows a typical RAMAN spectra plot for untreated hexagonal boron nitride;

FIG. 8 shows a RAMAN spectra plot for a hexagonal boron nitride containing fluid in accordance with a first example of the present invention;

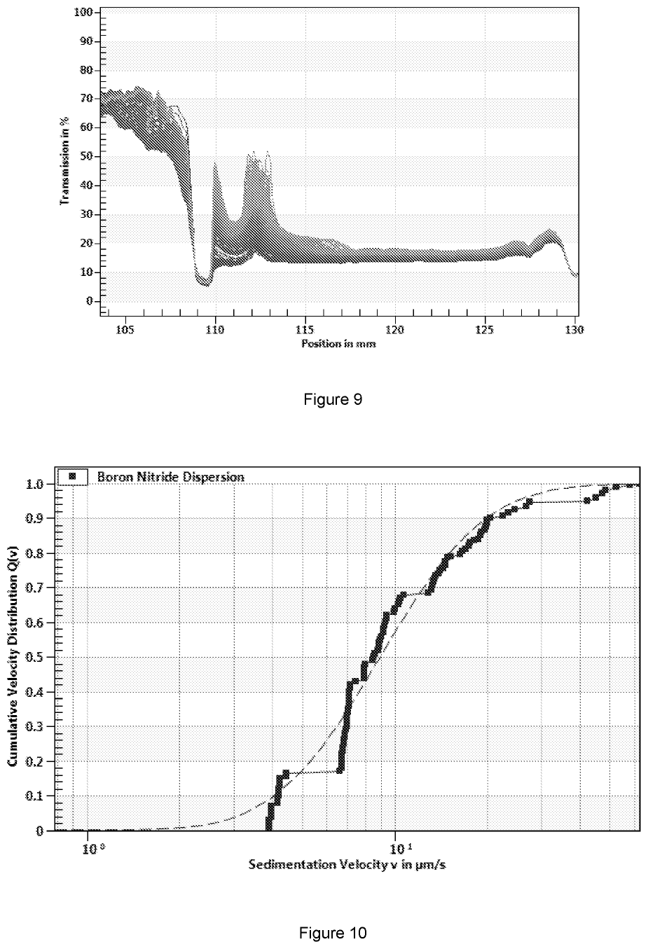

FIG. 9 shows a transmittance spectrum for the accelerated dispersion test for the hexagonal boron nitride containing fluid in accordance with the first example of the present invention;

FIG. 10 shows a graphical representation of the sedimentation velocity profile for the hexagonal boron nitride containing fluid in accordance with the first example of the present invention;

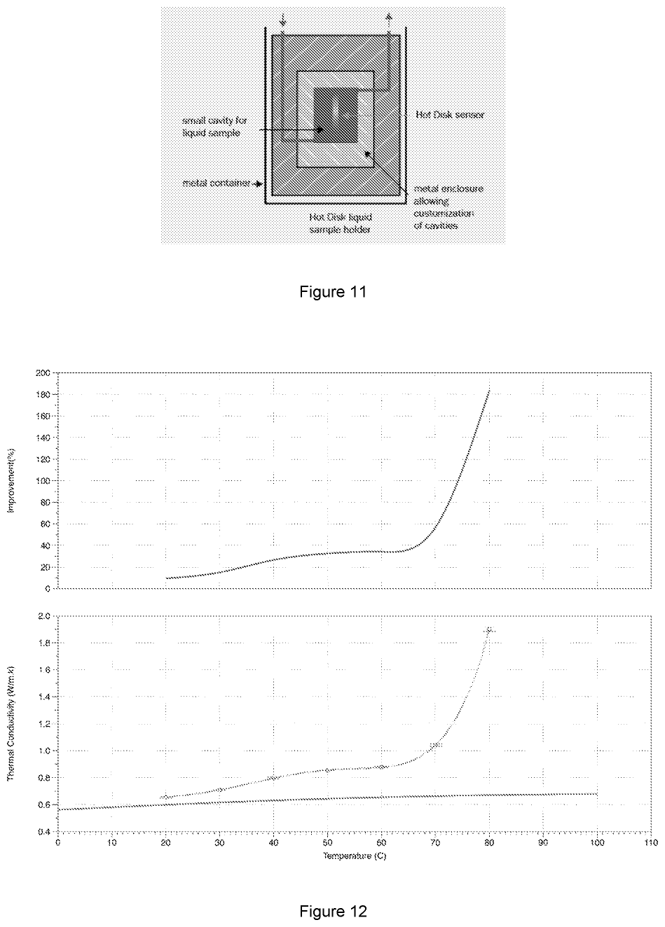

FIG. 11 illustrates a Hot Disk thermal conductivity liquid cell diagram;

FIG. 12 shows a graphical representation of thermal conductivity of the hexagonal boron nitride containing fluid in accordance with the first example of the present invention and water; and

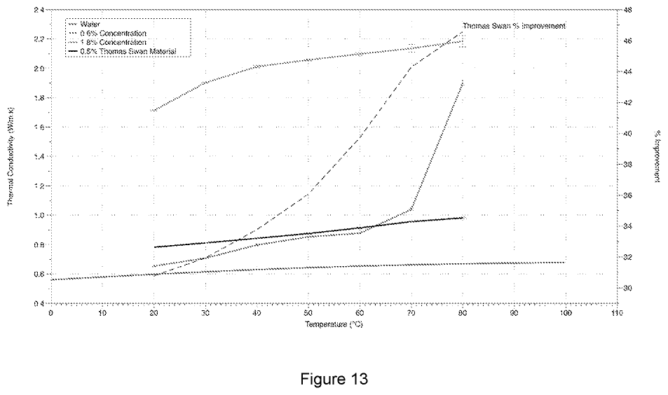

FIG. 13 show a graphical representation of thermal conductivity of the hexagonal boron nitride containing fluid in accordance with the first example of the present invention, hexagonal boron nitride containing fluid in accordance with a second example of the present invention and water.

### MATERIAL SELECTION

Any hexagonal boron nitride may be used as the raw material in the process of the present invention. It is the use of oxidation to functionalise the boron nitride which enables more effective exfoliation and production of single layers. However, it has been found that the selection of the raw material boron nitride can further enhance the production of single layers in dispersion.

The ability to produce single sheets is dependent on the strength of the Van der Waals forces bonding the sheets together. The use of functionalising ions introduced by oxidation causes the distance between the sheets to swell slightly, but the selection of the raw material can further enhance this effect.

Two variants of hexagonal boron nitride were used in the examples as follows:

### Turbostratic Hexagonal Boron Nitride

Turbostratic means the h-BN material has a crystal structure in which basal planes have slipped out of alignment. Accordingly, there is no guaranteed alignment of boron and nitrogen atoms layer-to-layer which will affect the inter-layer bond strength and produce different conditions for inter-layer positions for OH ions to attach. FIG. 3 graphically shows the turbostratic structure.

Momentive™ NX1 material was selected as this material is highly turbostratic and so the material properties afforded may allow for a more effective exfoliation.

FIG. 4 shows an electron micrograph of the NX1 material with a mean size of less than 1 micron and a discernible plate structure. There is not enough magnification to show the multiple layer structure.

### Commercially Available Hexagonal Boron Nitride

Elinova® 2D Boron Nitride (available from Thomas Swan) contains an average of 7 to 10 layers of h-BN. This material undergoes exfoliation of hexagonal boron nitride to produce atomically thin nano-platelets and is manufactured by a proprietary Direct Liquid Exfoliation process which exfoliates hexagonal boron nitride to produce 2 dimensional nano-platelets of boron nitride or 2D boron nitride. FIG. 5 shows a TEM micrograph of the materials grade with an average particle size of 0.5 to 1.0 μm.

### Oxidation

Haydale HDPlas® process was used to functionalise the 2D boron nitride material. In particular, oxygen (O₂ gas) functionalization was used which results in 0 but mainly OH (hydrogen being adsorbed from the atmosphere by the highly reactive surface) functionalization of the material which has been pictorially represented in FIG. 6.

The material treatment was based on the following basic process for a 100 g sample:
Material was first “cleaned” for 30 minutes using Argon gas. A plasma acceleration voltage of 0.5 kV was used with a 70 W energy input. 70 SCCM of Ar was used.
Using the same plasma energy levels, O₂ gas was then pumped into the chamber at 70 SCCM for 2 hours.

Where the process involves a liquid such as acetic acid being added to the plasma (in a stream of argon), CH₃, COOH and OH species are formed which attach to the edges of the 2D material at available junctions functionalising the material by oxidation.

### Ultrasonic/Centrifuge Treatment

The plasma treated material is subsequently subjected to ultrasonic treatment followed by optional centrifugation.

Prior to undergoing ultrasonic treatment, the plasma treated material is dispersed in deionised water. As a consequence of the functionalization of h-BN, the material wetted instantly. A Silverson L5M-A mixer was used to aid dispersion, at 500 rpm for 10 minutes.

The resulting dispersion is sonicated using a nano-lab QS1 system with a 0.5 inch tip. Energy exposure using a 30:30 second sonics ON:OFF profile. The temperature was limited to 40° C. using ice at 40% (max 125 W) power for safety reasons.

Subsequent optional centrifugation was carried out by techniques well known in the art.

### Example 1

A 100 g sample of commercially available hexagonal boron nitride was subjected to treatment with the Haydale HDPlas® process by the basic process set out above.

From this initial experiment it was shown that this treatment allowed a dispersion of hexagonal boron nitride in water to be formed without the use of a surfactant. The dispersion shows sedimentation though due to the particles being multi-layer with a large degree of aggregation as well. However, the sediment is easily re-dispersible showing that the surface treatment is very effective.

### Example 2—Variant 1—Turbostratic h-BN

Momentive™ NX1 was subjected to treatment with the Haydale HDPlas® process by the basic process set out above.

The plasma treated Momentive™ NX1 material was processed under the following conditions to render a suitable nanofluid:
500 ml of a 2.5% (wt/wt) dispersion of the functionalised h-BN in DI water was produced. The material wetted instantly. A silverson L5M-A mixer was used to aid dispersion, 500 rpm for 10 minutes.
The resultant dispersion was then sonicated using a nano-lab QS1 system with 0.5 inch tip for 2 hours. Energy exposure using a 30:30 second sonics ON:OFF profile. Temperature was limited to 40° C. using ice at 40% (max 125 W) power.
The sonicated material was centrifuged for 2 hours at 200 rpm.
400 ml of fluid was produced. Tests showed a 0.6% wt/wt h-BN content.

### Characterisation of Fluid

The determination of the degree of exfoliation is a fundamental measurement. This is done via RAMAN spectroscopy. RAMAN spectroscopy excites the sample using radiation supplied by a very high power monochromatic laser. This excitement causes an interaction with the sample which may be reflected, absorbed or scattered in some manner. It is the scattering of the radiation that occurs which can tell the Raman spectroscopist something of the samples molecular structure. The light is collected from the sample and analysed

Some of the scattered light is detected with a small change in wavelength (colour), this is known as the RAMAN scattered component. This scattering gives information on the bonds between atoms and as such can be used to identify molecules in the sample as the positioning of the bonds dictates the structure of the molecule.

The output from the spectrometer is a plot of the intensity against the wavelength shift caused by the RAMAN scattering (reported as cm⁻¹). FIG. 7 shows an example of a typical plot for untreated hexagonal boron nitride. The area of interest for hexagonal boron nitride is around 1300 (cm⁻¹) where the Van der Waals bonds are detected so the height of this peak indicates the number of these bonds and thus how many layers are present in the sample.

As the material was processed, each stage was analysed using a RAMAN spectrometer. FIG. 8 shows the RAMAN trace (concentrated around the 1350 cm⁻¹ region) for each stage, i.e. powder sample (i.e. the raw material), sonicated sample and centrifuged sample. It can be seen that processing from the powder to sonicated material there is a drop in the intensity. As these plots have been normalized, this drop in intensity is due only to the change in structure of the hexagonal boron nitride, i.e. the number of layers have been reduced significantly. The plots are normalized by shifting the RAMAN peak upwards in monolayers and downwards in bilayers with respect to its position in bulk h-BN.

The RAMAN spectra of the h-BN containing fluid clearly shows that there has been a high level of exfoliation in the material, i.e. there are significant levels of single layer material and many double layers.

To assess the stability of the manufactured nanofluid, an accelerated test was performed using a LUMiFuge® instrument (available from LUM GmbH). A spectrum was obtained over 50 minutes at 10 g with a 10 second read interval. Area of interest on profile 115 to 125 mm (Area 105 to 115 is affected by sample tube geometry and sample meniscus, and 125 to 130 is the bottom of the tube). A steady drop in the transmission can be seen which is indicative of some settling in the sample—although the transmission falls from 18% to 15% within this area. This shows that the higher yield single layer BN achieved by the method of the present invention results in a more stable dispersion than is achieved by the prior art methods.

FIG. 9 shows the spectra obtained from the LUMiFuge®. The spectrum shows some settling indicating that there are probably some multiple (2-3) layer particles, but the majority are single layer.

FIG. 10 shows the sedimentation velocity profile for the material from the LUMiFuge®. This shows no aggregation and a very slow sedimentation velocity 900 nm/second at 10 g acceleration. There is no sedimentation of the sample either.

### Thermal Properties

The fluids were tested for thermal conductivity across a wide range of temperatures (20 to 80° C.). The instrument used to measure the thermal conductivity was a Hot Disk TPS3500. FIG. 11 shows the general geometry of the measurement cell used.

Ten measurements of the sample were taken at each temperature, with five minutes between each measurement to allow the sample temperature to reach equilibrium again. Measurement conditions were 50 nW of energy for 10 seconds giving a 2 to 5 kelvin raise in temperature.

FIG. 12 shows the initial results for the thermal conductivity of the h-BN containing nanofluid. The bottom graph of the two shows a flat (lower) curve which is the thermal conductivity of water alone and the exponentially rising (upper) curve being the thermal conductivity of the h-BN containing fluid. The upper of the two graphs is a representation of the % increase in thermal conductivity compared to water.

At the typical operating temperatures of computer central processing units (60-85° C.), there is a rapid rise in efficiency from 35% at the lower limit and 180% at the higher limit, making this fluid an extremely good candidate for a thermal fluid.

### Example 3—Variant 2—Commercially Available h-BN

Variant 2 h-BN material has differing requirements to Variant 1. Variant 2 material can be used as a metalworking (cutting) fluid which requires not only good thermal properties, but also provides lubrication in high pressure areas such as the cutting tip at the metal interface.

To enhance the lubricity of the fluid, Variant 2 h-BN material was sourced and processed differently.

Utilising commercially available h-BN allows the processing of the material to be much simpler to make Variant 2 h-BN. The material had already undergone liquid exfoliation carried out by the manufacturer to reduce the number of stacks of h-BN. Therefore, following plasma processing the material was simply mixed into an aqueous dispersion and limited ultrasonic energy applied just to start the break-up of the agglomerates.
Material was first “cleaned” for 30 minutes using Argon gas. A plasma acceleration voltage of 0.5 kV was used with a 70 W energy input. 70 SCCM of Ar was used.
Using the same plasma energy levels, O₂ gas was then pumped into the chamber at 70 SCCM for 2 hours.
40 litres of a 0.5% (wt/wt) dispersion of the functionalised h-BN in DI water was produced. The material wetted instantly. A silverson L5M-A mixer was used to aid dispersion, 500 rpm for 10 minutes.
The resultant dispersion (in 5 litre aliquots) was then sonicated using a nano-lab QS1 system with 0.5 inch tip for 30 minutes. Energy exposure using a 30:30 second sonics ON:OFF profile. Temperature was limited to 40° C. using ice at 40% (max 125 W) power.
No centrifugation was applied.

Visible settling over a few days was observed indicating both aggregation and multi-layer morphology. The material was tested for thermal conductivity.

FIG. 13 shows the thermal conductivity measurements over 20 to 80° C. for a 0.6 wt % sample of the variant 1 material (blue line) and a 0.5 wt % sample of the variant 2 material (black solid line). The variant 1 material was concentrated to a 1.8 wt % sample (green line) by centrifugation to remove some of the liquid by techniques known in the art. The red line (the lowest line) represents the thermal conductivity of water and the black dashed line represents the % improvement of the variant 2 material over water.

As expected, water has the lowest thermal conductivity which remains relatively constant as temperature increases. The variant 2 material shows an improvement over water (as illustrated by the dashed line) with the thermal conductivity steadily increasing as the temperature increases. The thermal conductivity of the 0.6 wt % sample of the variant 1 material increases steadily to a temperature of 60° C., at which point it undergoes more rapid increases from 60° C. to 70° C. and from 70° to 80° C. The 1.8 wt % sample of the variant 1 material shows the high thermal conductivity across the temperature range.

The Variant 2 h-BN material is not as efficient at heat extraction at the 60 to 80° C. operating temperature. This efficiency is probably due to the Variant 2 material being multi-layer in its morphology. However, the Variant 2 h-BN material is better suited for use as a metalworking cutting fluid as the multilayer morphology enhances lubricity and, in use under shear, the layers easily separate due to the processing condition, thus enhancing the thermal properties.

In particular, while the Variant 2 h-BN may undergo settling of the material in use, early tests in a very high power liquid cooled PC system built to generate significant amount of heat from CPU and GPU have shown that the heat energy removed from the system increases from 94 Watts (joules per second) for prior art systems to 178 Watts for the Variant 2 h-BN containing fluid.

Accordingly, boron nitride containing fluids prepared by the method of the present invention provide better dispersions with weaker Van der Waals interactions between layers of the boron nitride and/or increased yields of single layer boron nitride. The boron nitride containing fluids thus provide improved properties including enhanced heat exchange/transfer and lubricity, thus lending themselves to use in heat transfer fluids for various applications such as electronics cooling or solar panels or as cutting fluids for metalworking processes.

1. A method of producing a boron nitride containing fluid comprising the steps of:
providing boron nitride;
oxidising the boron nitride to functionalise the surface of the boron nitride; and
dispersing the oxidised boron nitride in a base fluid to produce the boron nitride containing fluid.

2. The method according to claim 1 wherein oxidising the boron nitride comprises treating the boron nitride with plasma.

3. The method according to claim 2 wherein the boron nitride is treated with plasma in the presence of argon gas and oxygen.

4. The method according to claim 1 further comprising the step of sonicating the dispersion.

5. The method according to claim 4 wherein the boron nitride containing fluid is a nanofluid.

6. The method according to claim 5 wherein the boron nitride is provided in powder form.

7. The method according to claim 6 wherein the boron nitride is hexagonal boron nitride.

8. The method according to claim 7 wherein the hexagonal boron nitride is turbostratic.

9. The method according to claim 7 wherein the boron nitride is oxidised for 10 minutes to 5 hours.

10. The method according to claim 9 wherein the oxidised boron nitride is dispersed in water.

11. The method according to claim 10 wherein a mixer is used to aid dispersion of the oxidised boron nitride in the base fluid.

12. The method according to claim 11 wherein sonicating the dispersion comprises subjecting to ultrasound for a time period of from 10 minutes to 10 hours.

13. The method according to claim 12 further comprising the step of centrifuging the boron nitride containing fluid.

14. A boron nitride containing fluid prepared by the method of claim 13.

15. The boron nitride containing fluid of claim 14 wherein the fluid is a nanofluid.

16. A heat transfer fluid comprising a boron nitride containing fluid prepared by the method of claim 13.

17. Use of the heat transfer fluid according to claim 16 in electronics cooling system.

18. Use of the heat transfer fluid according to claim 16 in solar panels.

19. A dual function heat exchange and lubricity additive comprising a boron nitride containing fluid prepared by the method of claim 11.

20. A lubricant comprising a boron nitride containing fluid prepared by the method of claim 11.

21. Use of the dual function heat exchange and lubricity additive according to claim 19 as a cutting fluid.

22. Use of the lubricant according to claim 20 as a cutting fluid.
